(19) United States
(12) Patent Application Publication
(10) Pub. No.: US 2007/0146878 A1
(43) Pub. Date: Jun. 28, 2007

(54) Display unit

(75) Inventor: Chen-Sung Liao, Taichung City (TW)

Correspondence Address: OSTROLENK FABER GERB & SOFFEN, 1180 AVENUE OF THE AMERICAS, NEW YORK, NY, 100368403, US

(73) Assignee: Disk King Technology Co., Ltd.

(21) Appl. No.: 11/318,841

(22) Filed: Dec. 27, 2005

(51) Int. Cl. G03B 21/56

(52) U.S. Cl. 359/460

(57) ABSTRACT

A display unit includes: a housing having a front end defining a front opening, and an inner wall formed with first nut seats and support seats; screw rods, each of which extends through a respective support seat, a respective first nut seat, and the front opening, and each of which engages threadedly the respective first nut seat; a screen frame mounted on the front end of the housing and having an inner wall that is formed with second nut seats aligned respectively with the first nut seats and the support seats; a screen mounted on the screen frame for covering the front opening; and an image projecting device mounted in the housing for projecting images onto the screen. Each of the screw rods engages threadedly a respective second nut seat.

### BACKGROUND OF THE INVENTION

1. Field of the Invention

The invention relates to a display unit, more particularly to a display unit having a housing and a screen frame detachably mounted on the housing through a screw rod-and-nut assembly.

2. Description of the Related Art

Screen walls are commonly used in public places for showing images thereon. A large screen wall may include a plurality of display units that are stacked one above the other. The conventional display unit is disadvantageous in that when the screen of one of the stacked display units is damaged, replacement of the damaged screen is relatively inconvenient.

### SUMMARY OF THE INVENTION

Therefore, the object of the present invention is to provide a display unit that can overcome the aforesaid drawback of the conventional display unit.

Accordingly, a display unit of this invention comprises: a housing having a front end defining a front opening, and an inner wall that is formed with a plurality of first nut seats and a plurality of support seats, each of which is aligned with a respective one of the first nut seats; a plurality of screw rods, each of which extends through a respective one of the support seats, a respective one of the first nut seats, and the front opening, and each of which engages threadedly the respective one of the first nut seats; a screen frame mounted on the front end of the housing and having an inner wall that is formed with a plurality of second nut seats, each of which is aligned with a respective one of the first nut seats and a respective one of the support seats; a screen mounted on the screen frame for covering the front opening; and an image projecting device mounted in the housing for projecting images onto the screen. Each of the screw rods engages threadedly a respective one of the second nut seats so as to secure detachably the screen frame to the housing.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a display unit according to the present invention;

FIG. 2 is an assembled side sectional view of the preferred embodiment;

FIG. 3 is an assembled perspective view of the preferred embodiment; and

FIG. 4 is a side sectional view to illustrate how a screen frame together with a screen is detached from a housing of the preferred embodiment.

### DETAILED DESCRIPTION OF THE PREFERRED EMBODIMENT

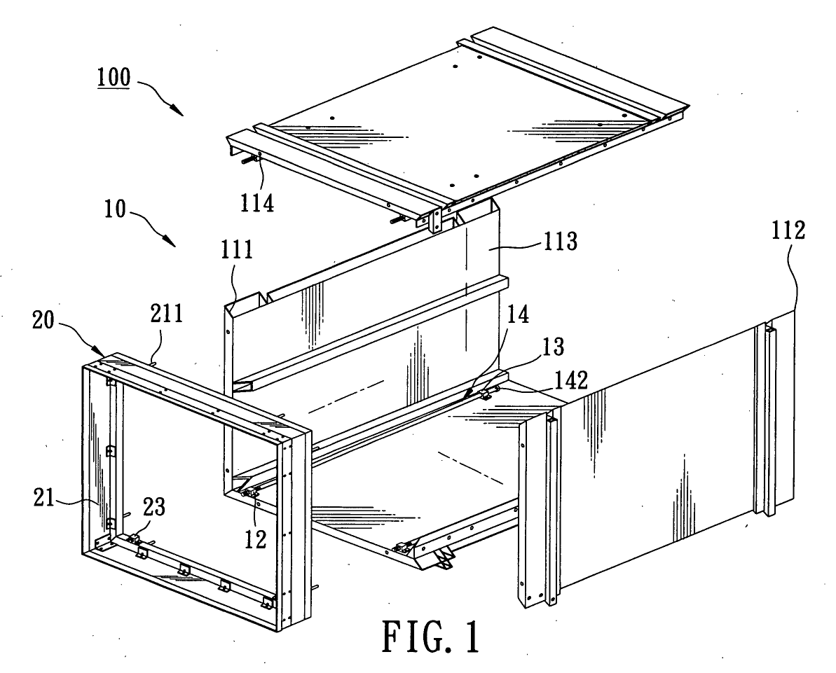

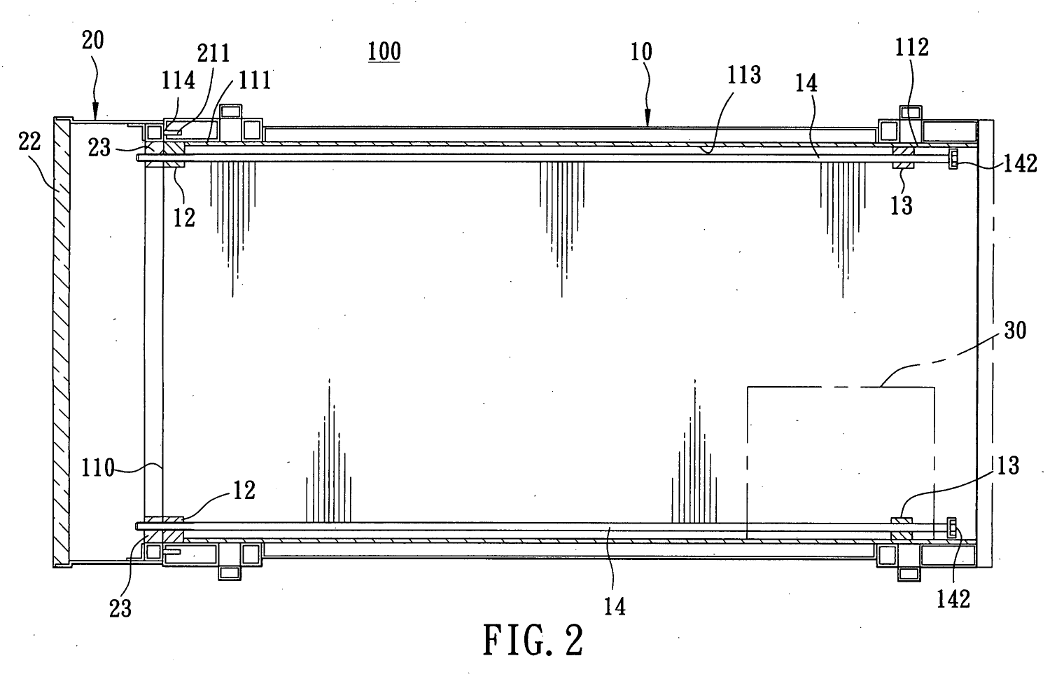

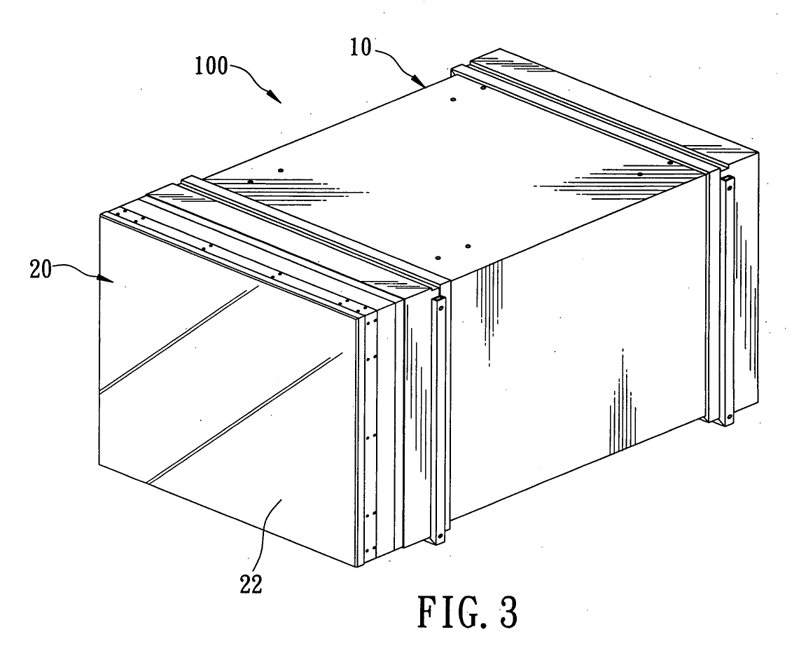

Referring to FIGS. 1 to 3, the preferred embodiment of a display unit 100 according to the present invention is shown to comprise: a housing 10 having a front end 111 defining a front opening 110, and an inner wall 113 that is formed with a plurality of first nut seats 12 and a plurality of support seats 13, each of which is aligned with a respective one of the first nut seats 12; a plurality of screw rods 14, each of which extends through a respective one of the support seats 13, a respective one of the first nut seats 12, and the front opening 110, and each of which engages threadedly the respective one of the first nut seats 12; a screen frame 20 mounted on the front end 111 and having an inner wall 21 that is formed with a plurality of second nut seats 23, each of which is aligned with a respective one of the first nut seats 12 and a respective one of the support seats 13; a screen 22 mounted on the screen frame 20 for covering the front opening 110; and an image projecting device 30 mounted in the housing 10 for projecting images onto the screen 22. Each of the screw rods 14 engages threadedly a respective one of the second nut seats 23 so as to secure detachably the screen frame 20 to the housing 10.

The housing 10 further has a rear end 112 opposite to the front end 111. Each of the first nut seats 12 is disposed adjacent to the front end 111 of the housing 10. Each of the support seats 13 is disposed adjacent to the rear end 112 of the housing 10.

The housing 10 is formed with a plurality of aligning holes 114, and the screen frame 20 is formed with a plurality of aligning pins 211, each of which extends into a respective one of the aligning holes 114, thereby facilitating alignment between the housing 10 and the screen frame 20.

Each of the screw rods 14 has a rear end provided with a knob 142 that is disposed proximate to the rear end 112 of the housing 10 for facilitating rotation of the screw rods 14 during mounting or dismounting of the screen frame 20.

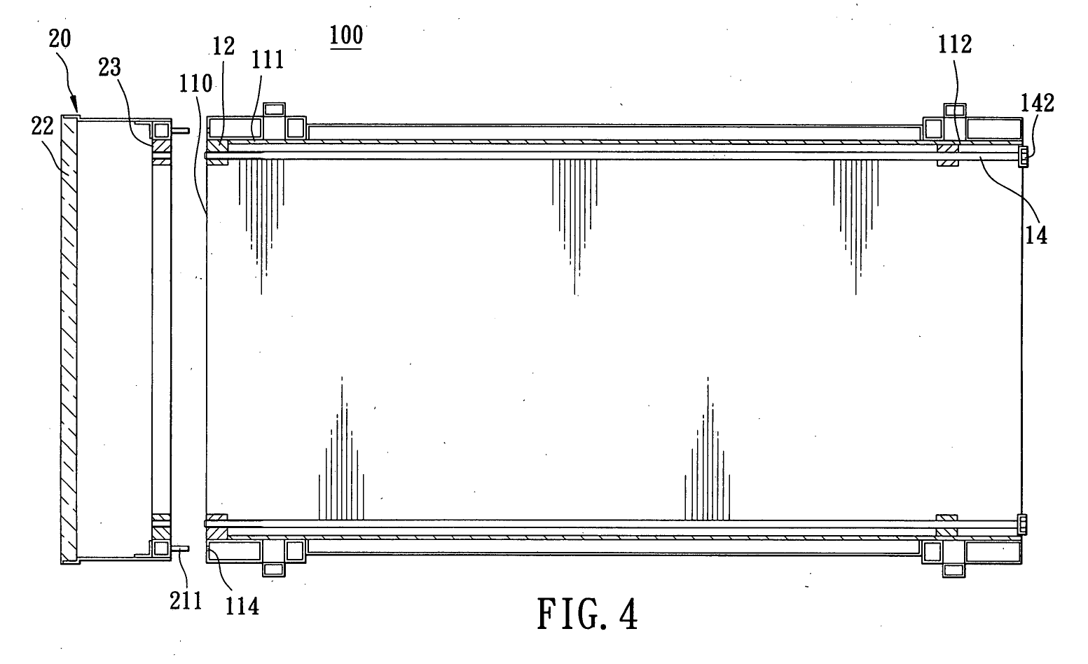

Referring to FIG. 4, when the screen 20 is to be replaced with a new one, each of the screw rods 14 is turned so as to be withdrawn from the respective second nut seat 23 through operation of the knob 142 of each of the screw rods 14 which can be accessed through the rear end 112 of the housing 10, thereby detaching the screen frame 20 from the housing 10.

With the inclusion of the screw rods 14 and the first and second nut seats 12, 23 in the display unit 100 of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A display unit comprising:
a housing having a front end defining a front opening, and an inner wall that is formed with a plurality of first nut seats and a plurality of support seats, each of which is aligned with a respective one of said first nut seats;
a plurality of screw rods, each of which extends through a respective one of said support seats, a respective one of said first nut seats, and said front opening, and each of which engages threadedly the respective one of said first nut seats;
a screen frame mounted on said front end of said housing and having an inner wall that is formed with a plurality of second nut seats, each of which is aligned with a respective one of said first nut seats and a respective one of said support seats;
a screen mounted on said screen frame for covering said front opening; and
an image projecting device mounted in said housing for projecting images onto said screen;
wherein each of said screw rods engages threadedly a respective one of said second nut seats so as to secure detachably said screen frame to said housing.

2. The display unit as claimed in claim 1, wherein said housing further has a rear end opposite to said front end, each of said first nut seats being disposed adjacent to said front end of said housing, each of said support seats being disposed adjacent to said rear end of said housing.

3. The display unit as claimed in claim 2, wherein said housing is formed with a plurality of aligning holes, said screen frame being formed with a plurality of aligning pins, each of which extends into a respective one of said aligning holes.
